(19) United States
(12) Patent Application Publication
(10) Pub. No.: US 2026/0019870 A1
(43) Pub. Date: Jan. 15, 2026

(54) Data Receiving Method, Data Transmission Method, and Communication Device

(71) Applicant: VIVO MOBILE COMMUNICATION CO., LTD., Dongguan (CN)

(72) Inventors: Yanxia Zhang, Dongguan (CN); Li Chen, Dongguan (CN)

(21) Appl. No.: 19/336,788

(22) Filed: Sep. 23, 2025

Related U.S. Application Data
(63) Continuation of application No. PCT/CN2024/083019, filed on Mar. 21, 2024.

(30) Foreign Application Priority Data
Mar. 24, 2023 (CN) 202310302417.2

(51) Int. Cl. H04W 28/06

(52) U.S. Cl. CPC H04W 28/06

(57) ABSTRACT

A data receiving method, which includes acquiring, by a receiving terminal, information about discarded target data of packet data convergence protocol (PDCP) layer, and updating, by the receiving terminal, data reception state of the PDCP layer based on the information about the discarded target data of the PDCP layer.

### CROSS-REFERENCE TO RELATED APPLICATIONS

This application is a Bypass Continuation Application of International Patent Application No. PCT/CN2024/083019 filed Mar. 21, 2024, and claims priority to Chinese Patent Application 202310302417.2, filed Mar. 24, 2023, the disclosures of which are hereby incorporated by reference in their entireties.

### BACKGROUND OF THE INVENTION

### Field of the Invention

This application pertains to the field of communication technologies, and relates to a data receiving method, a data transmission method, and a communication device.

### Description of Related Art

In certain circumstances, a data sending terminal or a data receiving terminal may trigger packet discarding due to congestion control and/or packet dependency. In the PDCP receiving mechanism, a receiving terminal at a PDCP layer maintains a receiving window based on state variables to receive packets falling within that window.

### SUMMARY OF THE INVENTION

Embodiments of this application provide a data receiving method and apparatus, a data transmission method and apparatus, and a communication device.

A first aspect provides a data receiving method. The method includes: acquiring, by a receiving terminal, information about discarded target data of packet data convergence protocol PDCP layer; and updating, by the receiving terminal, data reception state of the PDCP layer based on the information about the discarded target data of the PDCP layer.

A second aspect provides a data transmission method. The method includes: discarding, by a sending terminal, target data of the PDCP layer; and providing, by the sending terminal, first indication information to a receiving terminal, where the first indication information is used to indicate that the target data of the PDCP layer has been discarded.

A third aspect provides a data receiving apparatus. The apparatus includes: an acquisition module, configured to acquire information about discarded target data of packet data convergence protocol PDCP layer; and an updating module, configured to update of PDCP layer data reception state based on the information about the discarded target data of PDCP layer.

A fourth aspect provides a data transmission apparatus. The apparatus includes: a discarding module, configured to discard target data of the PDCP layer; and a providing module, configured to provide first indication information to a receiving terminal, where the first indication information is used to indicate that the target data of the PDCP layer has been discarded.

A fifth aspect provides a terminal. The terminal includes a processor and a memory. The memory stores a program or instructions capable of executing on the processor, and when the program or instructions are executed by the processor, the steps of the method according to the first aspect are implemented, or the steps of the method according to the second aspect are implemented.

A sixth aspect provides a terminal, including a processor and a communication interface, where the processor is configured to implement the steps of the method according to the first aspect or implement the steps of the method according to the second aspect. The communication interface is configured to communicate with an external device.

A seventh aspect provides a network-side device. The network-side device includes a processor and a memory. The memory stores a program or instructions capable of executing on the processor, and when the program or instructions are executed by the processor, the steps of the method according to the first aspect are implemented, or the steps of the method according to the second aspect are implemented.

An eighth aspect provides a network-side device, including a processor and a communication interface, where the processor is configured to implement the steps of the method according to the first aspect or implement the steps of the method according to the second aspect. The communication interface is configured to communicate with an external device.

A ninth aspect provides a non-transitory readable storage medium. The non-transitory readable storage medium stores a program or instructions, and when the program or instructions are executed by a processor, the steps of the method according to the first aspect are implemented, or the steps of the method according to the second aspect are implemented.

A tenth aspect provides a data transmission system, including a receiving terminal and a sending terminal. The receiving terminal may be configured to execute the steps of the method according to the first aspect, and the sending terminal may be configured to execute the steps of the method according to the second aspect.

An eleventh aspect provides a chip. The chip includes a processor and a communication interface. The communication interface is coupled to the processor, and the processor is configured to run a program or instructions to implement the method according to the first aspect or implement the method according to the second aspect.

A twelfth aspect provides a computer program/program product. The computer program/program product is stored in a storage medium, and the computer program/program product is executed by at least one processor to implement the steps of the method according to the first aspect or the steps of the method according to the second aspect.

### BRIEF DESCRIPTION OF THE DRAWINGS

FIG. 1 is a block diagram of a wireless communication system to which the embodiments of this application are applicable;

FIG. 2 is a schematic flowchart of a data receiving method according to an embodiment of this application;

FIG. 3 is a schematic flowchart of a data transmission method according to an embodiment of this application;

FIG. 4 is a schematic structural diagram of a data receiving apparatus according to an embodiment of this application;

FIG. 5 is a schematic structural diagram of a data transmission apparatus according to an embodiment of this application; and

FIG. 6 is a schematic structural diagram of a communication device according to an embodiment of this application.

### DESCRIPTION OF THE INVENTION

The following clearly describes the technical solutions in the embodiments of this application with reference to the accompanying drawings in the embodiments of this application. Apparently, the described embodiments are merely some rather than all of the embodiments of this application. All other embodiments obtained by persons of ordinary skill in the art based on the embodiments of this application fall within the protection scope of this application.

The terms “first”, “second”, and the like in this application are used to distinguish between similar objects instead of describing a specific order or sequence. It should be understood that the terms used in this way are interchangeable in appropriate circumstances so that the embodiments of this application can be implemented in other orders than the order illustrated or described herein. In addition, “first” and “second” are usually used to distinguish objects of a same type, and do not restrict the quantity of the objects. For example, there may be one or multiple first objects. In addition, “or” in the specification and claims represents at least one of connected objects. For example, “A or B” includes three cases, which are, case 1: including A but no B; case 2: including B but no A; and case 3: including both A and B. The character “/” in this specification generally indicates an “or” relationship between contextually associated objects.

The term “indicate” in this application may be either a direct indication (or an explicit indication) or an indirect indication (or an implicit indication). The direct indication may be understood as that a sender clearly informs a receiver of content such as specific information, an operation to be performed, or a result of a request in a sent indication; and the indirect indication may be understood as that the receiver determines corresponding information or makes a judgment based on the indication sent by the sender, or makes a judgment and determines, based on a judgment result, the operation to be performed or the result of the request.

It is worth noting that the technology described in the embodiments of this application is not limited to long term evolution (LTE)/LTE-Advanced (LTE-A) systems, and may also be used in other wireless communication systems such as code division multiple access (CDMA), time division multiple access (TDMA), frequency division multiple access (FDMA), orthogonal frequency division multiple access (OFDMA), single-carrier frequency-division multiple access (SC-FDMA), or other systems. The terms “system” and “network” in the embodiments of this application are often used interchangeably, and the technology described herein may be used in the above-mentioned systems and radio technologies as well as in other systems and radio technologies. In the following descriptions, a new radio (NR) system is described for an illustration purpose, and NR terms are used in most of the following descriptions, although these technologies may also be applied to other systems than the NR system, for example, the 6th generation (6G) communication system.

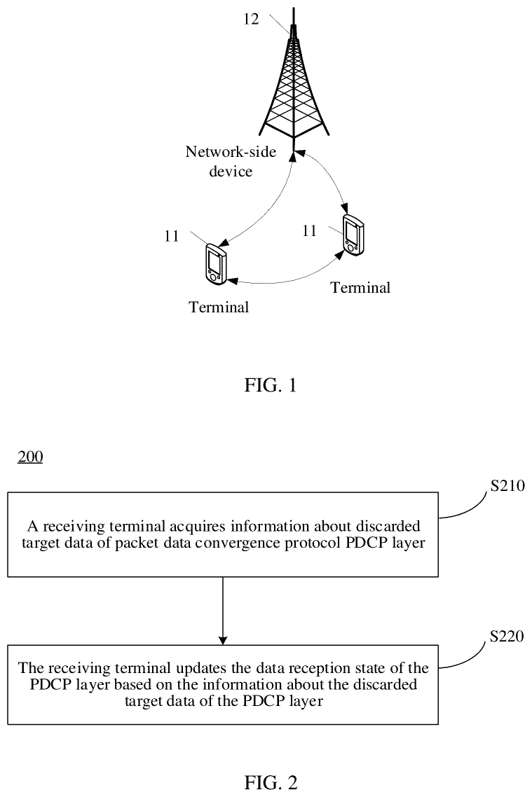

FIG. 1 is a block diagram of a wireless communication system to which the embodiments of this application are applicable. The wireless communication system includes a terminal 11 and a network-side device 12. The terminal 11 may be a terminal-side device, such as a mobile phone, a tablet personal computer, a laptop computer, a notebook computer, a personal digital assistant (PDA), a palmtop computer, a netbook, an ultra-mobile personal computer (UMPC), a mobile Internet device (MID), an augmented reality (AR)/virtual reality (VR) device, a robot, a wearable device, a flight vehicle (flight vehicle), vehicle user equipment (VUE), ship-borne equipment, pedestrian user equipment (PUE), a smart appliance (a home appliance with a wireless communication function, for example, a refrigerator, a television, a washing machine, or furniture), a game console, a personal computer (PC), a teller machine, or a self-service machine. The wearable device includes: smart watches, smart bands, smart earphones, smart glasses, smart jewelry (smart bangles, smart bracelets, smart rings, smart necklaces, smart ankle bangles, smart anklets, and the like), smart wristbands, smart clothing, and the like. The vehicle user equipment may also be referred to as a vehicle-mounted terminal, a vehicle-mounted controller, a vehicle-mounted module, a vehicle-mounted component, a vehicle-mounted chip, a vehicle-mounted unit, or the like. It should be noted that a specific type of the terminal 11 is not limited in the embodiments of this application. The network-side device 12 may include an access network device or a core network device, where the access network device may also be referred to as a radio access network (RAN) device, a radio access network function, or a radio access network unit. The access network device may include base stations, wireless local area network (WLAN) access points (AS), wireless fidelity (Wi-Fi) nodes, and the like. The base station may be referred to as a node B (NB), an evolved node B (eNB), the next generation node B (gNB), a new radio node B (NR Node B), an access point, a relay base station (RBS), a serving base station (SBS), a base transceiver station (BTS), a radio base station, a radio transceiver, a basic service set (BSS), an extended service set (ESS), a home Node B (HNB), a home evolved Node B, a transmission reception point (TRP), or other appropriate terms in the art. Provided that the same technical effects are achieved, the base station is not limited to any specific technical term. It should be noted that in the embodiments of this application, only the base station in the NR system is used as an example for description, and the specific type of the base station is not limited.

The core network device may include, but is not limited to, at least one of the following: a core network node, a core network function, a mobility management entity (MME), an access and mobility management function (AMF), a session management function (SMF), a user plane function (UPF), a policy control function (PCF), a policy and charging rules function (PCRF), an edge application server discovery function (EASDF), a unified data management (UDM), a unified data repository (UDR), a home subscriber server (HSS), a centralized network configuration (CNC), a network repository function (NRF), a network exposure function (NEF), a local NEF (L-NEF), a binding support function (BSF), or an application function (AF). It should be noted that in the embodiments of this application, only the core network device in the NR system is used as an example for introduction, and the specific type of the core network device is not limited.

To better understand the technical solutions provided in this application, the technology involved in this application is introduced first.

### (1) Brief Introduction to PDCP Receiving Mechanism

The length of a receiving window is specified by a protocol, essentially related to the length of a sequence number SN at a PDCP layer. For example, if PDCP SN=18 bit, a PDCP window length is Window_Size=2^{[pdcp-SN-SizeDL]-1}. To maintain a sliding receiving window, PDCP maintains the following reception state variables.
a. RX_NEXT: An RX_NEXT state variable, used to record a number of a next PDCP packet expected to be received.
b. RX_DELIV: An RX_DELIV state variable, used to record a smallest number of a packet that has not been delivered to an upper layer by PDCP.
c. RX_REORD: An RX_REORD state variable, used to record a sum of 1 and a packet number when reordering timing is triggered.

If packet discarding occurs at the packet data convergence protocol (PDCP) layer of a sending terminal, there will be gaps between PDCP sequence numbers (SN). In this case, the receiving terminal will continue to wait for the discarded data, causing unnecessary reordering delay at the receiving terminal. Moreover, in certain circumstances, the behavior of packet discarding occurs frequently, resulting in a very low data receiving efficiency of the receiving terminal.

The data receiving method, data transmission method, apparatuses, and communication device provided in the embodiments of this application are described in detail below with reference to the accompanying drawings through some embodiments and application scenarios thereof.

FIG. 2 is a schematic flowchart of a data receiving method according to an embodiment of this application. The method 200 can be executed by a data receiving terminal in data transmission, where the data receiving terminal may be a terminal or a network-side device, which is not specifically limited in this embodiment of this application. In other words, the method can be executed by software or hardware installed on the receiving terminal. As shown in FIG. 2, the method may include the following steps.
S210: A receiving terminal acquires information about discarded target data of packet data convergence protocol (PDCP) layer.

A PDCP layer is a layer in a long term evolution (LTE) wireless network, responsible for transmitting Internet protocol (IP) packets over a wireless link. The PDCP layer is used to aggregate data blocks to reduce a count of packets transmitted over the wireless link, and packets processed at the PDCP layer (which can be referred to as packets of PDCP layer data) are transmitted to a next layer.

In step S210, the receiving terminal acquires the information about the discarded target data of PDCP layer to determine the discarded target data of the PDCP layer, thereby avoiding continuing to wait for the discarded target data of the PDCP layer.

In one implementation, the target data of the PDCP layer satisfies at least one of the following.

(1) being Included in a Packet Set.

It can be understood that the packet set (such as a PDU set) includes multiple packets, such as PDCP PDUs.

(2) being a PDCP Protocol Data Unit (PDU).

The PDCP protocol data unit refers to a data unit transmitted at the PDCP layer, which is a type of data transmitted, and the PDCP protocol data unit is created and processed at the PDCP layer.

(3) being a PDCP Service Data Unit (SDU).

It should be noted that the PDCP service data unit is a data unit received from an upper layer, containing data from an upper layer application.

In one implementation, in a case that the target data of the PDCP layer belongs to a first packet set, the data receiving terminal discards other packets that have been received and belong to the first packet set.

It can be understood that the discarded target data of the PDCP layer may be all data in a packet set, that is, in this embodiment of this application, data at the PDCP layer is divided into packet sets, and the discarded data may be an entire packet set. Alternatively, the discarded target data of the PDCP layer may include a PDCP PDU or a PDCP SDU. For example, the first packet set includes a packet of target data of the PDCP layer numbered 1, a packet of target data of the PDCP layer numbered 2, and a packet of target data of the PDCP layer numbered 3. In this case, the receiving terminal has received the packets of target data of the PDCP layer numbered 1 and 2, but if a sending terminal indicates that the packet of target data of the PDCP layer numbered 3 has been discarded, the receiving terminal discards the packets of target data of the PDCP layer numbered 1 and 2.

In one implementation, step S210 includes at least one of the following (1) to (3).
(1) The receiving terminal receives first indication information sent by the sending terminal, where the first indication information is used to indicate that the target data of the PDCP layer has been discarded.

It can be understood that, according to a network side configuration or a protocol agreement, in a case that a data sending terminal discards the target data of the PDCP layer, the data sending terminal may send the first indication information to a data receiving terminal, where the first indication information is used to indicate that the target data of the PDCP layer has been discarded. For example, if a PDCP entity of the data sending terminal has discarded the target data, the PDCP entity provides the first indication information to a PDCP entity of the receiving terminal. Alternatively, if the sending terminal has discarded the target data of the PDCP layer of the packet numbered 2, the sending terminal sends the discarded first indication information of the target data of the PDCP layer of the packet numbered 2 to the receiving terminal.
(2) The receiving terminal acquires second indication information provided by a lower layer of the receiving terminal, where the second indication information is used to indicate that the target data of the PDCP layer has been discarded.

The lower layer may include a radio link control (RLC) layer or a media access control (MAC) layer.

For example, an RLC layer of the receiving terminal provides the second indication information to the PDCP layer of the receiving terminal, where the second indication information is used to indicate that target data of the PDCP layer (such as PDCP data PDU) has been discarded. For example, if indication information provided by an RLC entity of the receiving terminal indicates that a packet numbered 2 has been discarded by the sending terminal, the PDCP entity of the receiving terminal determines that the packet of target data of the PDCP layer numbered 2 has been discarded.
(3) The receiving terminal acquires a result of a packet set integrity check, where the packet set integrity check is used to determine whether data belonging to a same packet set has all been successfully received.

It can be understood that the packet set includes multiple packets. When receiving data, the receiving terminal may perform an integrity check on each packet set, that is, checking whether all packets in the packet set have all been received. If the result of the integrity check indicates that the data belonging to the same packet set has not all been received successfully, the receiving terminal may determine that the packets in the packet set have been discarded, thereby acquiring information about the discarded target data of the PDCP layer, for example, identifiers of the packet sets.
S220: The receiving terminal updates data reception state of the PDCP layer based on the information about the discarded target data of the PDCP layer.

It can be understood that, in a case that the receiving terminal acquires the information about the discarded target data of the PDCP layer, in order to avoid delay caused by continuing to wait for the discarded packets, the receiving terminal may update, based on the information of the discarded target data of the PDCP layer, the data reception state of the PDCP layer to resume data reception, thereby improving data efficiency.

In one implementation, S220 includes: updating, based on the information about the discarded target data of the PDCP layer, a state variable corresponding to a data receiving window.

It can be understood that, in a case that the receiving terminal determines that the target data of the PDCP layer has been discarded, in order to avoid delay caused by continuing to wait for the discarded packets, the receiving terminal accelerates window movement by updating the data reception state of the PDCP layer, so as to avoid still waiting for the discarded packets, where updating the data reception state of the PDCP layer may include updating a state variable corresponding to the data receiving window.

It should be noted that the window movement mentioned in this application can be understood as that the receiving terminal skips reception of the target data of the PDCP layer determined to be discarded, or can be understood as that the receiving terminal considers that the target data of the PDCP layer determined to be discarded has been received for processing, or can be understood that the receiving terminal triggers a preset delay or timer based on the target data of the PDCP layer determined to be discarded, and after the preset delay or timer expires, the receiving terminal skips the reception of the target data of the PDCP layer determined to be discarded, or the receiving terminal considers that the target data of the PDCP layer determined to be discarded has been received for processing.

In one implementation, updating the state variable corresponding to the data receiving window may include: in a case that a packet number of the target data of the PDCP layer is greater than or equal to an RX_NEXT state variable of the receiving window, the receiving terminal updates the RX_NEXT state variable to a first state variable value, where the first state variable value corresponds to a sum of a maximum packet number of the discarded PDCP layer data and 1.

It can be understood that, in a case that a packet number of the discarded target data of the PDCP layer is greater than or equal to an RX_NEXT state variable of the receiving window, updating a value of the RX_NEXT state variable to a next number following a maximum packet number of the discarded target data of the PDCP layer (that is, the maximum packet number of the discarded target data of the PDCP layer+1). In the PDCP layer, each packet has a unique number used to identify an order of the packet in a transmission process. For the sending terminal, the maximum packet number is the largest number among packets already sent by the sending terminal, and the next number is the number of a packet to be sent next. For the receiving terminal, the maximum packet number is the largest number among packets already received or the largest number among currently missing packets, and the next number is the number of a packet to be received next. For example, the RX_NEXT state variable may be RX_NEXT. If a packet number of the discarded target data of the PDCP layer is 0, and the RX_NEXT state variable RX_NEXT=0, RX_NEXT is updated to 1. Alternatively, if packet numbers of the discarded target data of the PDCP layer are 2, 3, 4, and 5, and RX_NEXT=2, RX_NEXT is updated to 6. It should be noted that if packet numbers of the discarded target data of the PDCP layer are 2 and 3, and RX_NEXT=4, RX_NEXT is not updated.

In one implementation, updating a state variable corresponding to the data receiving window may include: in a case that a packet number of the target data of the PDCP layer is greater than or equal to an RX_DELIV state variable of the receiving window, the receiving terminal updates the RX_DELIV state variable to a second state variable value, where the second state variable value is a packet number of the first PDCP layer data of the receiving terminal to be delivered to an upper layer that follows packets of the discarded target data of the PDCP layer, or the second state variable value corresponds to a sum of a maximum packet number of the discarded target data of the PDCP layer and 1.

It can be understood that in a case that a packet number of the target data of the PDCP layer is greater than or equal to the RX_DELIV state variable of the receiving window, the value of the RX_DELIV state variable is updated to a packet number of the first PDCP layer data of the receiving terminal to be delivered to an upper layer, or the second state variable value corresponds to a sum of a maximum packet number of the discarded data and 1. For example, the RX_DELIV state variable may be RX_DELIV. If a packet number of the discarded target data of the PDCP layer is 0, and RX_DELIV=0, RX_DELIV is updated to 1. Alternatively, if packet numbers of the discarded target data of the PDCP layer are 2, 3, 4, and 5, and RX_DELIV=2, RX_DELIV is updated to 6. Alternatively, if packet numbers of the discarded target data of the PDCP layer are 3, 4, and 5, and RX_DELIV=3, RX_DELIV is updated to 6.

In this implementation, the receiving terminal may modify parameters of the receiving window based on the information about the currently discarded target data of the PDCP layer, to update the current receiving window without waiting for the discarded data until a reordering timer expires, thereby improving the receiving efficiency.

In one implementation, to improve the receiving efficiency, the reordering timer may be processed. The updating, based on the information about the target data of the PDCP layer, a state variable corresponding to a data receiving window may further include: in a case that a reordering timer is running, if an RX_DELIV state variable of the receiving window is greater than or equal to an RX_REORD state variable, the receiving terminal stops the reordering timer.

It can be understood that, after the receiving terminal updates, based on the information about the discarded target data of the PDCP layer, the state variable corresponding to the data receiving window, if the updated RX_DELIV state variable is greater than or equal to the RX_REORD state variable and the reordering timer is running, the reordering timer is stopped. For example, the RX_REORD state variable may be RX_REORD. If packet numbers of the discarded target data of the PDCP layer are 2, 3, 4, and 5, and the RX_NEXT state variable RX_NEXT=2 and the RX_REORD state variable RX_REORD=2, the RX_DELIV state variable RX_DELIV is updated to 6. In this case, since the updated RX_DELIV is greater than RX_REORD, it indicates that packets of the target data of the PDCP layer with numbers less than RX_DELIV are no longer waiting to be received, that is, the reordering timer started before the update of RX_DELIV needs to be stopped.

It can be understood that the reordering timer is configured to detect data gaps, that is, the reordering timer is typically started when the data receiving terminal detects that data is not received in sequence. Therefore, in a case that the RX_DELIV state variable is greater than or equal to the RX_REORD state variable, it indicates that packets with numbers less than the RX_REORD state variable are considered to have been delivered to the upper layer or are no longer waiting, and thus the reordering timer needs to be stopped at that time.

In another implementation, to improve the receiving efficiency, the reordering timer may be processed. The updating, based on the information about the target data of the PDCP layer, a state variable corresponding to a data receiving window may further include: in a case that the reordering timer is not running, if the RX_DELIV state variable of the receiving window is less than the RX_NEXT state variable, the receiving terminal updates the RX_REORD state variable to a third state variable value and starts the reordering timer, where the third state variable value is equal to a state variable value of the RX_NEXT state variable.

It can be understood that, if the RX_DELIV state variable is less than the RX_NEXT state variable, it indicates that there is a number gap between a first packet waiting to be delivered by the receiving terminal and a next packet expected to be received, meaning that some packets have been discarded. In this case, the receiving terminal restarts the timer instead of waiting, and updates an RX_REORD state variable parameter to a third state variable value, where the third state variable value is equal to the RX_NEXT state variable.

In this implementation, when a packet has been discarded during transmission, the receiving terminal can restart the reordering timer instead of continuing to wait for the reordering timer to expire, reducing the waiting time of the receiving terminal and improving the data transmission efficiency.

In the above implementation, the receiving terminal takes corresponding measures based on the acquired information about the discarded target data of the PDCP layer, avoiding continuing to wait for the arrival of the target data of the PDCP layer, thereby ensuring the delay size and performance of data transmission.

In one implementation, the above implementation may further include at least one of the following (1) to (3).
(1) The receiving terminal can deliver PDCP layer data with a packet number less than an RX_DELIV state variable to an upper layer of the receiving terminal.

The RX_DELIV state variable is a number of a first packet that has not been delivered to the upper layer, and PDCP layer data with packet numbers less than the RX_DELIV state variable are packets already received by the receiving terminal. The receiving terminal delivers PDCP layer data with packet numbers less than the RX_DELIV state variable to the upper layer.
(2) The receiving terminal delivers a second packet set to the upper layer of the receiving terminal, where packet numbers of PDCP layer data in the second packet set are less than the RX_DELIV state variable, and all packets in the second packet set have been successfully received.

For example, if the second packet set includes PDCP layer data with packet numbers 1, 2, and 3, and the value of the RX_DELIV state variable is 4, PDCP layer data with packet numbers 1, 2, and 3 that have been received are delivered to the upper layer, that is, the second packet set is delivered to the upper layer.
(3) A third packet set is discarded or stored in a data buffer, where packet numbers of PDCP layer data in the third packet set are less than the RX_DELIV state variable, and at least one packet in the third packet set has not been successfully received.

For example, if the third packet set includes PDCP layer data with packet numbers 1, 2, 3, 4, and 5, where target data of the PDCP layer with packet numbers 4 and 5 have been discarded, the third packet set is incomplete. Therefore, the third packet set is discarded or stored in the data buffer, where the third packet set includes PDCP layer data with packet numbers 1, 2, and 3.

In this implementation, after determining the discarded data, the receiving terminal still transmits the received data to the upper layer. Even if a certain piece of data has been discarded, the receiving terminal may have already received data prior to that data. Therefore, when it is determined that a packet set to which each piece of data belongs is complete, the receiving terminal needs to transmit the received packets to the upper layer, so that the upper layer can continue to process data or perform other operations to ensure the integrity and correctness of data transmission.

In one implementation, the target data of the PDCP layer includes at least one of the following: PDCP layer data discarded by a sending terminal, PDCP layer data discarded by a lower layer of a receiving terminal, or PDCP layer data discarded by a PDCP layer of a receiving terminal.

It can be understood that, during data transmission, packets may be lost due to various reasons, such as network congestion, transmission errors, or hardware failures. Therefore, the discarded PDCP layer data may be determined by the sending terminal, or determined by the lower layer of the receiving terminal, or determined by the PDCP layer of the receiving terminal.

In one implementation, the PDCP layer data discarded by the PDCP layer of the receiving terminal may include: packets of discarded data acquired based on a result of a packet set integrity check by the PDCP layer of the receiving terminal. In other words, the PDCP layer of the receiving terminal may discard, based on the result of the packet set integrity check, packets in the packet set in a case that the result of the packet set integrity check indicates that the packet set is incomplete.

In this embodiment of this application, in a case that the receiving terminal determines, based on the acquired information about the target data of the PDCP layer, that the target data of the PDCP layer has been discarded, the receiving terminal updates data reception state of the PDCP layer based on the information about the discarded target data of the PDCP layer, which can accelerate the movement of the receiving window, improving the data receiving efficiency of the receiving terminal, thereby avoiding unnecessary reordering delay.

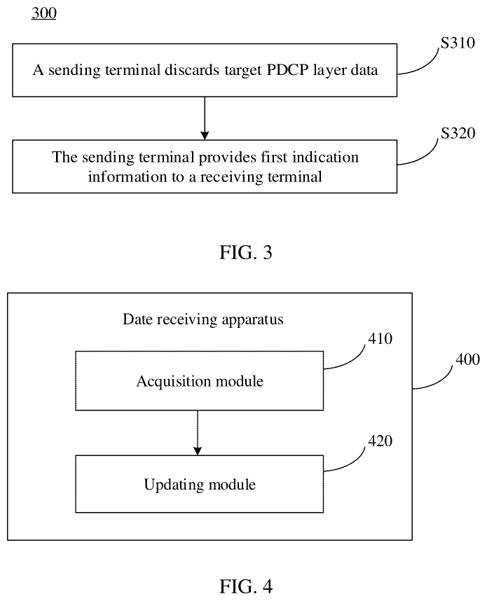

FIG. 3 shows a schematic flowchart of a data transmission method according to an embodiment of this application. The method 300 can be performed by a data sending terminal in data transmission, where the data sending terminal includes but is not limited to a terminal or a network-side device as shown in FIG. 1. In other words, the method may be performed by software or hardware installed on the sending terminal. As shown in FIG. 3, the method may include the following steps.

S310: The sending terminal discards target data of the PDCP layer.

In one implementation, the target data of the PDCP layer satisfies at least one of the following.
(1) Being included in a packet set.

In other words, the discarded target data of the PDCP layer may be all packets in a packet set, where one packet set may include multiple packets. For example, a packet set may be a PDU set, that is, a packet set includes multiple PDUs, and certainly it is not limited to this, and a packet set may alternatively be an SDU set.
(2) Being a PDCP protocol data unit.

In other words, the discarded target data of the PDCP layer may be a PDCP PDU, where a PDCP PDU refers to data that is transmitted to a next layer after an SDU at this layer is processed in a specific format.
(3) Being a PDCP service data unit.

In other words, the discarded target data of the PDCP layer may be a PDCP SDU, where a PDCP SDU refers to data that is transmitted from the upper layer to the PDCP layer and that has not been processed.

S320: The sending terminal provides first indication information to a receiving terminal, where the first indication information is used to indicate that the target data of the PDCP layer has been discarded.

In one implementation, the first indication information may include at least one of the following.
(1) A number of a packet set.

For example, if the sending terminal discards an entire packet set based on congestion control, the sending terminal provides indication information of the packet set, such as a PDU set SN, to the receiving terminal. It can be understood that a PDU set SN refers to a sequence number used to recognize a packet in the PDCP layer. In the PDCP layer, each packet is assigned with a unique PDU set SN. This sequence number is allocated during a packet data convergence protocol process to ensure the correctness and integrity of packets during transmission. The PDU set SN can be used to detect packet loss and duplication, to ensure the reliability of data transmission.
(2) A number range of the packet set.

For example, a PDU set SN range refers to a range of PDU set SNs in the PDCP layer.
(3) A number of the first packet in the packet set.

For example, an SN of the start PDU of the PDU Set refers to an SN number of the first PDU in a PDU Set. For example, the sending terminal may indicate (2) and (3), and the receiving terminal may determine, based on the number of the first packet in the packet set and the number range of the packet set that are indicated by the first indication information, numbers of all packets in the packet set.
(4) A number of the last packet in the packet set.

For example, an SN of the end PDU of the PDU Set refers to an SN number of the last PDU in a PDU Set. For example, the sending terminal may indicate (2) and (4), and the receiving terminal may determine, based on the number of the last packet in the packet set and the number range of the packet set that are indicated by the first indication information, numbers of all packets in the packet set.
(5) A number of any one or more packets in the packet set.

For example, an SN of a PDU within the PDU set refers to an SN number of a certain PDU in a PDU Set. For example, the sending terminal may indicate a number of one or more discarded packets in the packet set.
(6) A number range of packets in the packet set.

For example, an SN of a PDU within the PDU set range refers to a range of packet numbers in the PDCP layer.
(7) A PDCP layer sequence number.

For example, a PDCP SN, where a PDCP SN refers to a sequence number used to recognize a packet in the PDCP layer.
(8) A range of PDCP layer sequence numbers.

For example, a PDCP SN range, where a PDCP SN range refers to a range of sequence numbers of packets in the PDCP layer.
(9) A packet count of PDCP layer data, used to indicate a packet count of multiple consecutive pieces of PDCP layer data that have been discarded.

It should be noted that the packets of the multiple consecutive pieces of PDCP layer data may span packet sets, for example, if the last 2 packets in packet set 1 and the first 1 packet in packet set 2 have been discarded, the packet count of the PDCP layer data is 3.

Optionally, in a case that one or more consecutive packets have been discarded, the sending terminal may further provide, based on the first indication information, information about a packet of discarded target data of the PDCP layer with a largest number. For example, if a PDCP sending terminal discards packets of target data of the PDCP layer numbered 1, 2, and 3, the first indication information may carry only information about the packet of target data of the PDCP layer numbered 3.
(10) A count of packet sets, used to indicate a count of multiple consecutive packet sets that have been discarded. For example, in a case that the sending terminal have discarded two consecutive packet sets, it may indicate, based on the first indication information, that the number of packet sets of consecutively discarded data is 2.

Optionally, in a case that one or more consecutive packets have been discarded, the sending terminal may further provide, based on the first indication information, information about a discarded packet set with a largest number. For example, if a PDCP sending terminal has discarded packet sets numbered 1, 2, and 3, the first indication information may carry only information about the packet set numbered 3.

In one implementation, that the sending terminal provides first indication information to a receiving terminal includes at least one of the following (1) and (2).
(1) The sending terminal sends the first indication information via a PDCP control protocol data unit.

For example, the sending terminal may inform, by setting a PDU Type, a data receiving terminal that the PDCP control protocol data unit PDCP control PDU is used to indicate that a specific packet has been discarded.
(2) The sending terminal sends the first indication information via a PDCP data protocol data unit.

For example, the PDCP data protocol data unit (PDCP data PDU) may be a packet that does not contain a data payload, for example, the sending terminal may send the first indication information via a header of a PDCP data PDU.

In one implementation, that the sending terminal provides first indication information to a receiving terminal may include at least one of the following (1) and (2).
(1) A PDCP entity of the sending terminal provides the first indication information to the receiving terminal via a primary path associated with the PDCP entity.

In one implementation, the primary path may be determined based on a first rule or configured by a network-side device.

For example, the first rule includes one or more of the following:
a transmission path located in a primary cell group is the primary path;
a transmission path with a smallest path number is the primary path;
a transmission path with a largest path number is the primary path;
a transmission path carrying high-priority data is the primary path; and
a transmission path carrying high-significance data is the primary path.
(2) A PDCP entity of the sending terminal provides the first indication information to the receiving terminal via any path associated with the PDCP entity.

The any path means that there are still other paths in addition to the primary path. These paths, in addition to providing the first indication information to the receiving terminal, may also be used for specific tasks and functions, such as data detection, correction, encryption, and decryption.

In one implementation, before the sending terminal provides first indication information to a receiving terminal, the sending terminal performs at least one of the following (1) and (2).
(1) Acquiring first on/off indication information, where the first indication information is used for the sending terminal to enable or disable a sending function for the first indication information in a case that the target data of the PDCP layer has been discarded.

It can be understood that, after discarding the target data of the PDCP layer, the sending terminal acquires the first on/off indication information. In a case that the first on/off indication information indicates enabling a sending function for the first indication information, the first indication information is sent. In a case that the first on/off indication information indicates disabling a sending function for the first indication information, the first indication information is not sent. Through this implementation, the first on/off indication information can be flexibly set according to actual application needs.
(2) Acquiring second configuration information, where the second configuration information is used for configuring the sending terminal to send the first indication information in a case that a first event is satisfied, where the first event includes any one of the following: a handover event, an uplink data handover event, and a connection re-establishment event.

The handover event may include handover of a radio interface, the uplink data handover event includes an event about a terminal switching from one base station to another base station, and the connection re-establishment event may include a process in which a terminal needs to re-establish a connection after the terminal is disconnected from a base station. The above events may all lead to data transmission loss. Therefore, the sending terminal sends the first indication information to the receiving terminal by acquiring the second configuration information in a case that the first event is satisfied.

In this embodiment of this application, the sending terminal may notify the receiving terminal of information about discarded data in a case that the data has been discarded. The receiving terminal, upon learning that the data cannot be successfully transmitted, may accelerate window movement to prepare to receive a next packet, avoiding unnecessary reordering delay, thereby improving the data receiving efficiency of the receiving terminal.

The data receiving method provided in this embodiment of this application can be performed by a data receiving apparatus. In this embodiment of this application, an example in which a data receiving apparatus performs a data receiving method is used to describe the data receiving apparatus provided in this embodiment of this application.

FIG. 4 is a schematic structural diagram of a data receiving apparatus according to an embodiment of this application. As shown in FIG. 4, the apparatus 400 primarily includes an acquisition module 410 and an updating module 420.

In this embodiment of this application, the acquisition module 410 is configured to acquire information about discarded target data of packet data convergence protocol PDCP layer; and the updating module 420 is configured to update data reception state of the PDCP layer based on the information about the discarded target data of the PDCP layer.

In one implementation, the acquisition module 410 acquiring the information about the discarded target data of packet data convergence protocol PDCP layer includes at least one of the following: receiving first indication information sent by a sending terminal, where the first indication information is used to indicate that the target data of the PDCP layer has been discarded; acquiring second indication information provided by a lower layer of the receiving terminal, where the second indication information is used to indicate that the target data of the PDCP layer has been discarded; or acquiring, by the receiving terminal, a result of a packet set integrity check, where the packet set integrity check is used to determine whether the data belonging to the same packet set has all been successfully received.

In one implementation, the target data of the PDCP layer satisfies at least one of the following: being included in a packet set; being a PDCP protocol data unit; or being a PDCP service data unit.

In one implementation, the updating module 420 is configured to: in a case that the target data of the PDCP layer belongs to a first packet set, discard other packets that have been received and belong to the first packet set.

In one implementation, the updating module 420 updating data reception state of the PDCP layer based on the information about the discarded target data of the PDCP layer includes: updating, based on the information about the discarded target data of the PDCP layer, a state variable corresponding to a data receiving window.

In one implementation, the updating module 420 updating data reception state of the PDCP layer based on the information about the discarded target data of the PDCP layer includes at least one of the following: in a case that a packet number of the target data of the PDCP layer is greater than or equal to an RX_NEXT state variable of the receiving window, the receiving terminal updates the RX_NEXT state variable to a first state variable value, where the first state variable value corresponds to a sum of a maximum packet number of the discarded target data of the PDCP layer and 1; or in a case that a packet number of the target data of the PDCP layer is greater than or equal to an RX_DELIV state variable of the receiving window, the receiving terminal updates the RX_DELIV state variable to a second state variable value, where the second state variable value is a packet number of the first PDCP layer data of the receiving terminal to be delivered to an upper layer that follows packets of the discarded target data of the PDCP layer, or the second state variable value corresponds to a sum of a maximum packet number of the discarded target data of the PDCP layer and 1.

In one implementation, the updating module 420 is further configured to: in a case that a reordering timer is running, when an RX_DELIV state variable of the receiving window is greater than or equal to an RX_REORD state variable, stop, by the receiving terminal, the reordering timer.

In one implementation, the updating module 420 is further configured to: in a case that the reordering timer is not running, if the RX_DELIV state variable of the receiving window is less than the RX_NEXT state variable, update the RX_REORD state variable to a third state variable value and start the reordering timer by the receiving terminal, where the third state variable value is equal to a state variable value of the RX_NEXT state variable.

In one implementation, the updating module 420 is further configured to perform at least one of the following: deliver, by the receiving terminal, PDCP layer data with packet numbers less than the RX_DELIV state variable to the upper layer of the receiving terminal; deliver, by the receiving terminal, a second packet set to the upper layer of the receiving terminal, where packet numbers of PDCP layer data in the second packet set are less than the

RX_DELIV state variable, and all packets in the second packet set have been successfully received; or discard a third packet set or store the third packet set in a data buffer, where packet numbers of PDCP layer data in the third packet set are less than the RX_DELIV state variable, and at least one packet in the third packet set has not been successfully received.

The data receiving apparatus in this embodiment of this application may be an electronic device, such as an electronic device having an operating system, or may be a component such as an integrated circuit or a chip in an electronic device. The electronic device may be a terminal or another device other than a terminal. For example, the terminal may include, but is not limited to, the types of the terminal 11 listed above, and the another device may be a server, a network attached storage (NAS). This is not specifically limited in this embodiment of this application.

The data receiving apparatus provided in this embodiment of this application can implement the processes implemented by the receiving terminal in the method embodiment shown in FIG. 2, with the same technical effects achieved. To avoid repetition, details are not described herein again.

The data transmission method provided in this embodiment of this application can be performed by a data transmission apparatus. In this embodiment of this application, an example in which a data transmission apparatus performs a data transmission method is used to describe the data transmission apparatus provided in this embodiment of this application.

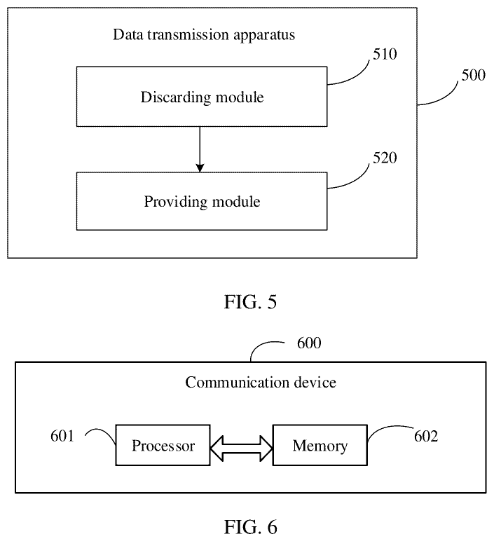

FIG. 5 is a schematic structural diagram of a data transmission apparatus according to an embodiment of this application. As shown in FIG. 5, the apparatus 500 primarily includes a discarding module 510 and a providing module 520.

In this embodiment of this application, the discarding module 510 is configured to discard target data of the PDCP layer; and the providing module 520 is configured to provide first indication information to a receiving terminal, where the first indication information is used to indicate that the target data of the PDCP layer has been discarded.

In one implementation, the target data of the PDCP layer satisfies at least one of the following: being included in a packet set; being a PDCP protocol data unit; or being a PDCP service data unit.

In one implementation, the first indication information includes at least one of the following: a number of a packet set; a number range of the packet set; a number of the first packet in the packet set; a number of the last packet in the packet set; a number of any one or more packets in the packet set; a number range of packets in the packet set; a PDCP layer sequence number; a range of PDCP layer sequence numbers; a packet count of PDCP layer data, used to indicate a packet count of multiple consecutive pieces of PDCP layer data that have been discarded; or a count of packet sets, used to indicate a count of multiple consecutive packet sets that have been discarded.

In one implementation, the providing module 520 providing first indication information to a receiving terminal includes one of the following: sending the first indication information via a PDCP control protocol data unit; and sending the first indication information via a PDCP data protocol data unit.

In one implementation, the providing module 520 providing first indication information to a receiving terminal includes any one of the following: providing the first indication information to the receiving terminal via a primary path associated with a PDCP entity; and providing the first indication information to the receiving terminal via any path associated with a PDCP entity by the sending terminal.

In one implementation, the primary path is determined based on a first rule or configured by a network-side device.

In one implementation, the first rule includes one or more of the following: a transmission path located in a primary cell group is the primary path; a transmission path with a smallest path number is the primary path; a transmission path with a largest path number is the primary path; a transmission path carrying high-priority data is the primary path; and a transmission path carrying high-significance data is the primary path.

In one implementation, the providing module 520 is further configured to perform at least one of the following: acquiring first on/off indication information, where the first indication information is used to enable or disable a sending function for the first indication information in a case that the target data of the PDCP layer has been discarded; or acquiring second configuration information, where the second configuration information is used to configure that the first indication information is sent in a case that a first event is satisfied, where the first event includes any one of the following: a handover event, an uplink data handover event, and a connection re-establishment event.

The data transmission apparatus in this embodiment of this application may be an electronic device, such as an electronic device having an operating system, or may be a component such as an integrated circuit or a chip in an electronic device. The electronic device may be a terminal or another device other than a terminal. For example, the terminal may include, but is not limited to, the types of the terminal 11 listed above, and the another device may be a server, a network attached storage (NAS). This is not specifically limited in this embodiment of this application.

The data transmission apparatus provided in this embodiment of this application can implement the processes implemented by the sending terminal in the method embodiment shown in FIG. 3, with the same technical effects achieved. To avoid repetition, details are not described herein again.

Optionally, as shown in FIG. 6, an embodiment of this application further provides a communication device 600, including a processor 601 and a memory 602. The memory 602 stores a program or instructions capable of executing on the processor 601. For example, in a case that the communication device 600 is a terminal, when the program or instructions are executed by the processor 601, the steps of the foregoing data receiving method embodiment are implemented, or the steps of the foregoing data transmission method embodiment are implemented, with the same technical effects achieved. In a case that the communication device 600 is a network-side device, when the program or instructions are executed by the processor 601, the steps of the foregoing data receiving method embodiment are implemented, or the steps of the foregoing data transmission method embodiment are implemented, with the same technical effects achieved. To avoid repetition, details are not described herein again.

An embodiment of this application further provides a data transmission system, including a receiving terminal and a sending terminal. The receiving terminal implements the processes of the foregoing data receiving method embodiment during execution, and the sending terminal implements the processes of the foregoing data transmission method embodiment during execution.

An embodiment of this application further provides a non-transitory readable storage medium, where the non-transitory readable storage medium stores a program or instructions, and when the program or instructions are executed by a processor, the processes of the foregoing data receiving method embodiment are implemented, or the processes of the foregoing data transmission method embodiment are implemented, with the same technical effects achieved. To avoid repetition, details are not described herein again.

The processor is a processor in the terminal described in the foregoing embodiments. The non-transitory readable storage medium includes a non-transitory computer-readable storage medium such as a computer read-only memory ROM, a random access memory RAM, a magnetic disk, or an optical disc.

An embodiment of this application further provides a chip. The chip includes a processor and a communication interface, where the communication interface is coupled to the processor, and the processor is configured to run a program or instructions to implement the processes of the foregoing data receiving method embodiment or implement the processes of the foregoing data transmission method embodiment, with the same technical effects achieved. To avoid repetition, details are not described herein again.

It should be understood that the chip mentioned in this embodiment of this application may also be referred to as a system-level chip, a system chip, a chip system, a system-on-chip, or the like.

It is worth noting that the embodiments and implementations of this application can be applied to various scenarios discussed and involved in 3GPP, including extended reality (XR).

An embodiment of this application further provides a computer program/program product, where the computer program/program product is stored in a storage medium, and the computer program/program product is executed by at least one processor to implement the processes of the foregoing data receiving method embodiment, or implement the processes of the foregoing data transmission method embodiment, with the same technical effects achieved. To avoid repetition, details are not described herein again.

It should be noted that in this specification, the terms “include”, “comprise”, or any of their variants are intended to cover a non-exclusive inclusion, such that a process, method, article, or apparatus that includes a list of elements not only includes those elements but also includes other elements that are not expressly listed, or further includes elements inherent to such process, method, article, or apparatus. Without more restrictions, an element preceded by the statement “includes a . . . ” does not preclude the presence of other identical elements in the process, method, article, or apparatus that includes the element. In addition, it should be noted that the scope of the method and apparatus in the implementations of this application is not limited to functions being performed in the order shown or discussed, but may further include functions being performed at substantially the same time or in a reverse order, depending on the functions involved. For example, the described method may be performed in an order different from the order described, and various steps may be added, omitted, or combined. In addition, features described with reference to some examples may be combined in other examples.

Based on the description of the foregoing implementations, persons skilled in the art may clearly understand that the method in the foregoing embodiments can be implemented through a computer software product on a necessary hardware platform or certainly through hardware only. The computer software product is stored in a storage medium (for example, a ROM, a RAM, a magnetic disk, or an optical disc) and includes several instructions for instructing a terminal or a network-side device to perform the method described in the embodiments of this application.

The foregoing describes the embodiments of this application with reference to the accompanying drawings. However, this application is not limited to the foregoing implementations. These implementations are merely for illustration rather than limitation. Inspired by this application, persons of ordinary skill in the art may develop many other forms of implementations without departing from the essence of this application and the protection scope of the claims, and all these implementations shall fall within the protection scope of this application.

What is claimed is:

1. A data receiving method, comprising:
acquiring, by a receiving terminal, information about discarded target data of packet data convergence protocol (PDCP) layer; and
updating, by the receiving terminal, data reception state of the PDCP layer based on the information about the discarded target data of the PDCP layer.

2. The method according to claim 1, wherein the acquiring, by a receiving terminal, information about discarded target data of PDCP layer comprises at least one of the following:
receiving, by the receiving terminal, first indication information sent by a sending terminal, wherein the first indication information is used to indicate that the target data of the PDCP layer has been discarded;
acquiring, by the receiving terminal, second indication information provided by a lower layer of the receiving terminal, wherein the second indication information is used to indicate that the target data of the PDCP layer has been discarded; or
acquiring, by the receiving terminal, a result of a packet set integrity check, wherein the packet set integrity check is used to determine whether data belonging to a same packet set has all been successfully received.

3. The method according to claim 1, wherein the target data of the PDCP layer satisfies at least one of the following:
being included in a packet set;
being a PDCP protocol data unit; or
being a PDCP service data unit.

4. The method according to claim 3, wherein the method further comprises:
in a case that the target data of the PDCP layer belongs to a first packet set, discarding, by the receiving terminal, other packets that have been received and belong to the first packet set.

5. The method according to claim 1, wherein the updating, by the receiving terminal, data reception state of the PDCP layer based on the information about the discarded target data of the PDCP layer comprises:
updating, based on the information about the discarded target data of the PDCP layer, a state variable corresponding to a data receiving window.

6. The method according to claim 5, wherein the updating, based on the information about the discarded target data of the PDCP layer, a state variable corresponding to a data receiving window comprises at least one of the following:
in a case that a packet number of the target data of the PDCP layer is greater than or equal to an RX_NEXT state variable of the receiving window, updating, by the receiving terminal, the RX_NEXT state variable to a first state variable value, wherein the first state variable value corresponds to a sum of a maximum packet number of the discarded target data of the PDCP layer and 1; or
in a case that a packet number of the target data of the PDCP layer is greater than or equal to an RX_DELIV state variable of the receiving window, updating, by the receiving terminal, the RX_DELIV state variable to a second state variable value, wherein the second state variable value is a packet number of the first PDCP layer data of the receiving terminal to be delivered to an upper layer that follows packets of the discarded target data of the PDCP layer, or the second state variable value corresponds to a sum of a maximum packet number of the discarded target data of the PDCP layer and 1.

7. The method according to claim 5, wherein the updating, based on the information about the target data of the PDCP layer, a state variable corresponding to a data receiving window comprises:
in a case that a reordering timer is running, when an RX_DELIV state variable of the receiving window is greater than or equal to an RX_REORD state variable, stopping, by the receiving terminal, the reordering timer.

8. The method according to claim 5, wherein the updating, based on the information about the target data of the PDCP layer, a state variable corresponding to a data receiving window comprises:
in a case that a reordering timer is not running, when an RX_DELIV state variable of the receiving window is less than an RX_NEXT state variable, updating, by the receiving terminal, an RX_REORD state variable to a third state variable value, and starting the reordering timer;
wherein the third state variable value is equal to a state variable value of the RX_NEXT state variable.

9. The method according to claim 1, wherein the method further comprises at least of the following:
delivering, by the receiving terminal, PDCP layer data with a packet number less than an RX_DELIV state variable to an upper layer of the receiving terminal;
delivering, by the receiving terminal, a second packet set to an upper layer of the receiving terminal, wherein packet numbers of PDCP layer data in the second packet set are less than an RX_DELIV state variable, and all packets in the second packet set have been successfully received; and
discarding a third packet set or storing the third packet set in a data buffer, wherein packet numbers of PDCP layer data in the third packet set are less than the RX_DELIV state variable, and at least one packet in the third packet set has not been successfully received.

10. A data transmission method, comprising:
discarding, by a sending terminal, target data of packet data convergence protocol (PDCP) layer; and
providing, by the sending terminal, first indication information to a receiving terminal, wherein the first indication information is used to indicate that the target data of the PDCP layer has been discarded.

11. The method according to claim 10, wherein the target data of the PDCP layer satisfies at least one of the following:
being included in a packet set;
being a PDCP protocol data unit; or
being a PDCP service data unit.

12. The method according to claim 11, wherein the first indication information comprises at least one of the following:
a number of the packet set;
a number range of packet sets;
a number of the first packet in the packet set;
a number of the last packet in the packet set;
a number of any one or more packets in the packet set;
a number range of packets in the packet set;
a PDCP layer sequence number;
a range of PDCP layer sequence numbers;
a packet count of PDCP layer data, used to indicate a packet count of multiple consecutive pieces of PDCP layer data that have been discarded; or
a count of the packet sets, used to indicate a count of multiple consecutive packet sets that have been discarded.

13. The method according to claim 10, wherein the providing, by the sending terminal, first indication information to a receiving terminal comprises one of the following:
sending, by the sending terminal, the first indication information via a PDCP control protocol data unit; and
sending, by the sending terminal, the first indication information via a PDCP data protocol data unit.

14. The method according to claim 13, wherein the providing, by the sending terminal, first indication information to a receiving terminal comprises any one of the following:
providing, by a PDCP entity of the sending terminal, the first indication information to the receiving terminal via a primary path associated with the PDCP entity; and
providing, by a PDCP entity of the sending terminal, the first indication information to the receiving terminal via any path associated with the PDCP entity.

15. The method according to claim 14, wherein the primary path is determined based on a first rule or configured by a network-side device.

16. The method according to claim 15, wherein the first rule comprises one or more of the following:
a transmission path located in a primary cell group is the primary path;
a transmission path with a smallest path number is the primary path;
a transmission path with a largest path number is the primary path;
a transmission path carrying high-priority data is the primary path; and
a transmission path carrying high-significance data is the primary path.

17. The method according to claim 10, wherein before the providing, by the sending terminal, first indication information to a receiving terminal, the sending terminal performs at least one of the following:
acquiring first on/off indication information, wherein the first indication information is used for the sending terminal to enable or disable a sending function for the first indication information in a case that the target data of the PDCP layer has been discarded; or
acquiring second configuration information, wherein the second configuration information is used for configuring the sending terminal to send the first indication information in a case that a first event is satisfied, wherein the first event comprises any one of the following: a handover event, an uplink data handover event, and a connection re-establishment event.

18. A communication device, comprising a processor and a memory, wherein the memory stores a program or instructions capable of executing on the processor, and the program or instructions, when executed by the processor, cause the processor to perform:
acquiring information about discarded target data of packet data convergence protocol (PDCP) layer; and
updating data reception state of the PDCP layer based on the information about the discarded target data of the PDCP layer.

19. The communication device according to claim 18, wherein the program or instructions, when executed by the processor, cause the processor to perform at least one of the following:
receiving first indication information sent by a sending terminal, wherein the first indication information is used to indicate that the target data of the PDCP layer has been discarded;
acquiring second indication information provided by a lower layer of the communication device, wherein the second indication information is used to indicate that the target data of the PDCP layer has been discarded; or
acquiring a result of a packet set integrity check, wherein the packet set integrity check is used to determine whether data belonging to a same packet set has all been successfully received.

20. A communication device, comprising a processor and a memory, wherein the memory stores a program or instructions capable of executing on the processor, and the program or instructions, when executed by the processor, cause the processor to implement the steps of the data transmission method according to claim 10.
